(19) United States
(12) Patent Application Publication
(10) Pub. No.: US 2024/0051424 A1
(43) Pub. Date: Feb. 15, 2024

(54) INTEROPERABILITY PLATFORM FOR CHARGING INFRASTRUCTURE

(71) Applicant: Rivian IP Holdings, LLC, Plymouth, MI (US)

(72) Inventors: Tyler Jennings Bennett, Long Beach, CA (US); Tyler Jay Erikson, Torrance, CA (US); Kyle Robert Underhill, Los Angeles, CA (US); Trent Warnke, Novi, MI (US); Sara Eslinger, Redwood City, CA (US); Sarah Hipel, Detroit, MI (US)

(21) Appl. No.: 17/885,044

(22) Filed: Aug. 10, 2022

(51) Int. Cl. B60L 53/66; H02J 7/00; B60L 53/68

(52) U.S. Cl. CPC B60L 53/665; H02J 7/00032; H02J 7/0013; H02J 7/0048; B60L 53/68

(57) ABSTRACT

A data processing system can receive, from a plurality of electric vehicles (EVs), data on a plurality of charging stations. The data can include first data on availability of the charging stations and second data on performance of the charging stations captured by the plurality of EVs via a plurality of power cables coupled with the charging stations. The system can determine, based on the data, availability of a charging station of the plurality of charging stations. The system can determine, based on the data captured via a power cable of the plurality of power cables, performance of the charging station. The system can generate, based on the availability and the performance, a score for the charging station and provide, based on a comparison of the score with a second score for a second charging station of the plurality of charging stations, an indication corresponding to the charging station.

### INTRODUCTION

Electric vehicles (EVs) can be powered using batteries that store energy. The EV batteries can be charged.

### SUMMARY

The present disclosure is generally directed to providing, to an electric vehicle, an indication of a charging station based on aggregated data on availability and performance of a plurality of charging stations. Charging EVs at various charging stations can be challenging due to the variability across different charging stations that can have varying performance. For example, when an EV driver seeks to use a charging station to charge the electric vehicle, the EV driver may be unaware that this particular charging station is unavailable or performing below its rated performance levels. This can incur delays and impact the EV driver's experience. The present technical solution provides systems and methods to provide to the EV or other device an indication based on aggregated data on availability and performance of EV charging stations gathered from other EVs. The present solution can aggregate data on charging stations from various EVs using the charging stations and use the aggregated data to determine availability and performance of each of the EV charging stations and score the charging stations based on their availability and performance. The present solution can provide, to the EV or other device, one or more indications of the one or more charging stations having high scores corresponding to improved availability and performance, which the EV driver can use to use to charge the EV with improved user experience.

At least one aspect is directed to a system that includes a data processing system having one or more processors coupled with memory. The data processing system can receive, from a first electric vehicle, data regarding a first charging station. The data regarding the first charging station can include at least one of data corresponding to performance of the first charging station captured by the first electric vehicle via a power cable that couples the first electric vehicle with the first charging station and data corresponding to availability of the first charging station. The data processing system can receive, from a second electric vehicle, data regarding a second charging station. The data regarding the second charging station can include at least one of data corresponding to performance of the second charging station captured by the second electric vehicle via a power cable that couples the second electric vehicle with the second charging station and data corresponding to availability of the second charging station. The data processing system can determine, based on the data regarding the first charging station and the data regarding the second charging station, availability of at least one of the first charging station and the second charging station. The data processing system can determine, based on at least one of the data corresponding to performance of the first charging station and the data corresponding to performance of the second charging station, performance of at least one of the first charging station and the second charging station. The data processing system can generate, based on the availability of at least one of the first charging station and the second charging station and the performance of at least one of the first charging station and the second charging station, a score for the first charging station and a score for the second charging station. The data processing system can provide, based on a comparison of the score for the first charging station and the score for the second charging station, an indication corresponding to one of the first charging station and the second charging station.

At least one aspect is directed to a system. The system can include a data processing system having one or more processors coupled with memory. The data processing system can receive, from a plurality of electric vehicles, data on a plurality of charging stations. The data can include first data corresponding to availability of the plurality of charging stations. The data can include second data corresponding to performance of the plurality of charging stations captured by the plurality of electric vehicles via a plurality of power cables that couple the plurality of electric vehicles with the plurality of charging stations. The data processing system can determine, based on the data, availability of a charging station of the plurality of charging stations. The data processing system can determine, based on the data captured via a power cable of the plurality of power cables, performance of the charging station. The data processing system can generate, based on the availability and the performance, a score for the charging station. The data processing system can provide, based on a comparison of the score for the charging station with a second score for a second charging station of the plurality of charging stations, an indication corresponding to the charging station.

At least one aspect is directed to a method. The method can include receiving, by one or more processors from a first electric vehicle, data regarding a first charging station. The data regarding the first charging station including at least one of data corresponding to performance of the first charging station captured by the first electric vehicle via a power cable that couples the first electric vehicle with the first charging station and data corresponding to availability of the first charging station. The method can include receiving, by the one or more processors from a second electric vehicle, data regarding a second charging station, the data regarding the second charging station including at least one of data corresponding to performance of the second charging station captured by the second electric vehicle via a power cable that couples the second electric vehicle with the second charging station and data corresponding to availability of the second charging station. The method can include determining, by the one or more processors, based on the data regarding the first charging station and the data regarding the second charging station, availability of at least one of the first charging station and the second charging station. The method can include determining, by the one or more processors, based on at least one of the data corresponding to performance of the first charging station and the data corresponding to performance of the second charging station, performance of at least one of the first charging station and the second charging station. The method can include generating, by the one or more processors, based on the availability of at least one of the first charging station and the second charging station and the performance of at least one of the first charging station and the second charging station, a score for the first charging station and a score for the second charging station. The method can include providing, by the one or more processors, based on a comparison of the score for the first charging station and the score for the second charging station, an indication corresponding to at least one of the first charging station and the second charging station.

At least one aspect is directed to a method. The method can include receiving, by one or more processors from a plurality of electric vehicles, data corresponding to a plurality of charging stations. The data can include first data corresponding to availability of the plurality of charging stations. The data can include second data corresponding to performance of the plurality of charging stations captured by the plurality of electric vehicles via a plurality of power cables that couple the plurality of electric vehicles with the plurality of charging stations. The method can include determining, by the one or more processors based on the data, availability of a charging station of the plurality of charging stations. The method can include determining, by the one or more processors based on the data captured via a power cable of the plurality of power cables, performance of the charging station. The method can include generating, by the one or more processors based on the availability and the performance, a score for the charging station. The method can include providing, by the one or more processors based on a comparison of the score for the charging station with a second score for a second charging station of the plurality of charging stations, an indication corresponding to the charging station.

At least one aspect is directed to a non-transitory computer-readable medium storing instructions. The instructions, when executed by at least one processor, cause the at least one processor to receive, from a first electric vehicle, data regarding a first charging station. The data regarding the first charging station can include at least one of data corresponding to performance of the first charging station captured by the first electric vehicle via a power cable that couples the first electric vehicle with the first charging station and data corresponding to availability of the first charging station. The instructions, when executed by at least one processor, cause the at least one processor to receive, from a second electric vehicle, data regarding a second charging station. The data regarding the second charging station can include at least one of data corresponding to performance of the second charging station captured by the second electric vehicle via a power cable that couples the second electric vehicle with the second charging station and data corresponding to availability of the second charging station. The instructions, when executed by at least one processor, cause the at least one processor to determine, based on the data regarding the first charging station and the data regarding the second charging station, availability of at least one of the first charging station and the second charging station. The instructions, when executed by at least one processor, cause the at least one processor to determine, based on at least one of the data corresponding to performance of the first charging station and the data corresponding to performance of the second charging station, performance of at least one of the first charging station and the second charging station. The instructions, when executed by at least one processor, cause the at least one processor to generate, based on the availability of at least one of the first charging station and the second charging station and the performance of at least one of the first charging station and the second charging station, a score for the first charging station and a score for the second charging station. The instructions, when executed by at least one processor, cause the at least one processor to provide, based on a comparison of the score for the first charging station and the score for the second charging station, an indication corresponding to at least one of the first charging station and the second charging station.

At least one aspect is directed to a non-transitory computer-readable medium. The non-transitory computer-readable medium can store instructions. The instructions, when executed by at least one processor, cause the at least one processor to receive, from a plurality of electric vehicles, data corresponding to a plurality of charging stations. The instructions can cause the at least one processor to determine, for each respective charging station of the plurality of charging stations, based on the data, availability of the respective charging station. The availability of the respective charging station can correspond to whether the respective charging station provides service to one or more electric vehicles of the plurality of electric vehicles. The instructions can cause the at least one processor to determine, for each respective charging station of the plurality of charging stations, based on the data captured via a power cable of the respective charging station, performance of the respective charging station. The performance of the respective charging station can be determined based on an amount of power throughput between the respective charging station and the one or more electric vehicles of the plurality of electric vehicles. The instructions can cause the at least one processor to generate, based on the availability and the performance of a charging station of the plurality of charging stations, a score for the charging station. The instructions can cause the at least one processor to provide, in response to the score for the charging station exceeding a second score for a second charging station of the plurality of charging stations determined based on the availability and the performance of the second charging station, an indication corresponding to the charging station.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle connected to a charging station.

FIG. 2A depicts an example of one or more battery packs.

FIG. 2B depicts an example of one or more battery modules.

FIG. 2C depicts a cross sectional view of an example battery cell.

FIG. 2D depicts a cross sectional view of another example of a battery cell.

FIG. 2E depicts a cross sectional view of another example of a battery cell.

FIG. 3 is a block diagram illustrating an architecture for a computer system that can be employed to implement elements of the systems and methods described and illustrated herein.

FIG. 4 is a block diagram illustrating an example of a system to provide to an electric vehicle an indication based on information on availability and performance of charging stations.

FIG. 5 is a flow diagram illustrating an example method for providing to an electric vehicle an indication based on information on availability and performance of charging stations.

### DETAILED DESCRIPTION

Following below are more detailed descriptions of various concepts related to, and implementations of, methods, apparatuses, and systems of monitoring availability and performance of charging stations. The various concepts introduced above and discussed in greater detail below may be implemented in any of numerous ways.

This disclosure is generally directed to a technical solution that can provide an indication of an available and highly performing charging station to an EV based on information on availability and performance of various charging stations. As EVs run using the energy stored in their batteries, once EV batteries get discharged from the usage, charging stations (e.g., chargers) can be used to replenish their battery energy. However, as chargers can be provided by various entities, their operation and performance can vary. These variations can impact the performance of the charging session between the EV and the charger. For example, an EV driver may be unaware that a selected or possibly available EV charger is unavailable, or is performing below its rated performance level. This can adversely affect the EV driver's experience and create delays and frustration during the EV charge events.

The present technical solution provides to the EV, (e.g. for display to the EV driver,) an indication on the one or more charging stations to use based on, or including, updated information on availability and performance of EV charging stations. The present solution can aggregate data from various EVs utilizing different charging stations and can use the aggregated data to determine availability and performance characteristics of each of the EV charging stations. For example, using aggregated data from various EVs, the present solution can determine that an EV charger is no longer operational and therefore alert the EV, and its driver, that this EV charger is unavailable. The present solution can utilize the aggregated data to determine that another EV charger is both available and having high performance characteristics including, for example, providing power consistently and at high power levels. The present solution can score and rank the EV chargers based on their availability and performance and provide to the EV an indication of the one or more EV chargers with the highest scores for the EV to use. Based on the indication, the EV driver can select the most suitable EV charger to use and avoid delays associated with unavailable or underperforming EV charging stations.

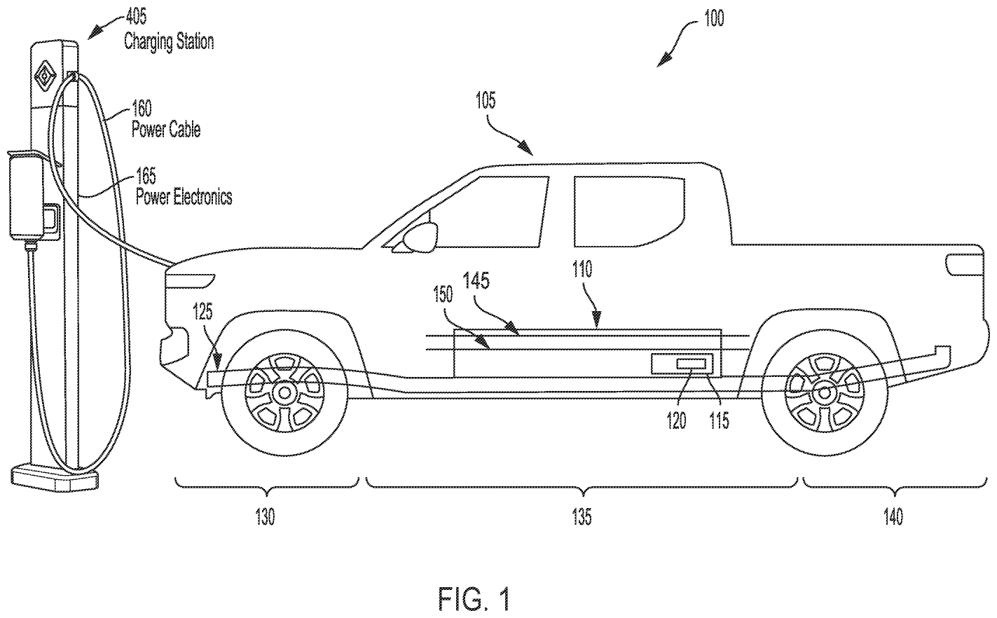

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105. Battery packs 110, battery modules 115 or battery cells 120 can be charged using a battery station 405, having a power electronics 165 and a power cable 160 connecting to the electric vehicle 105.

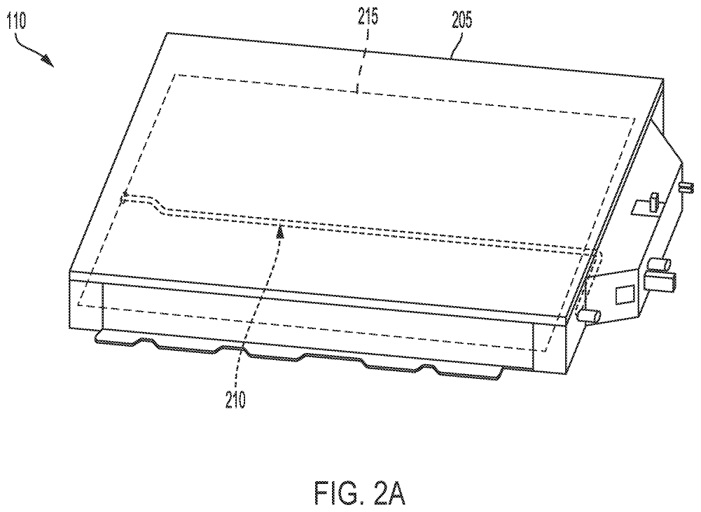

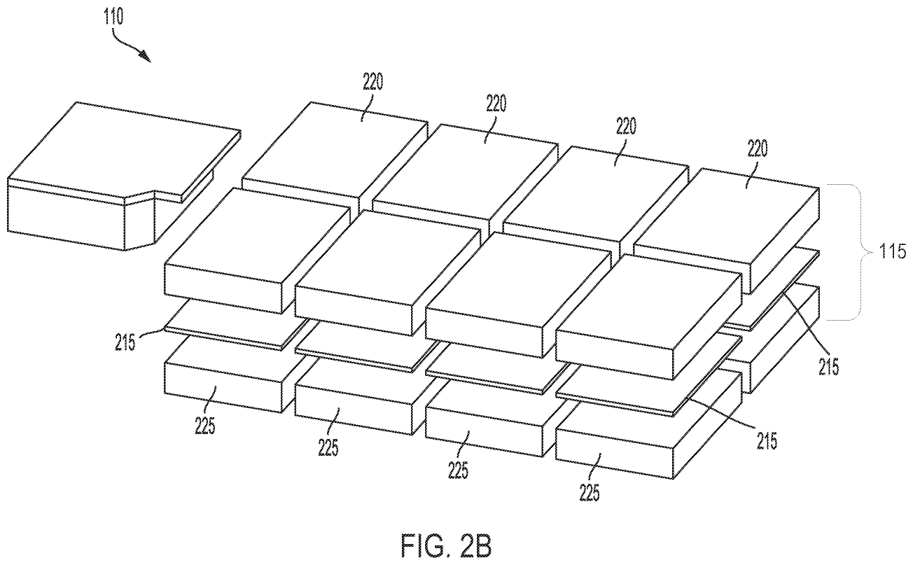

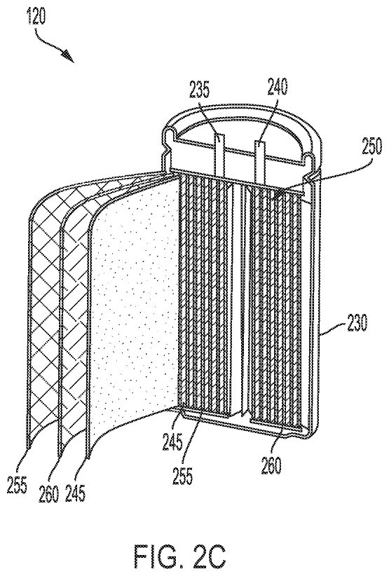

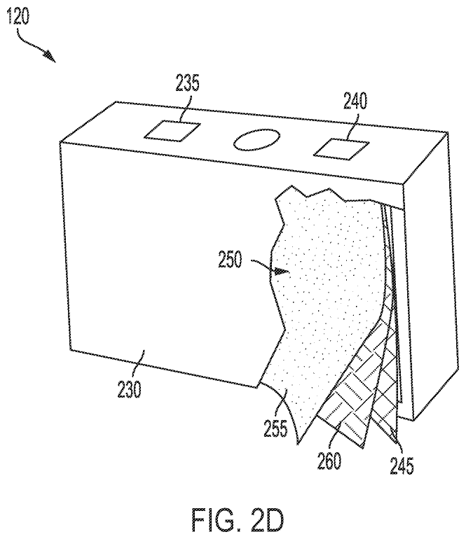

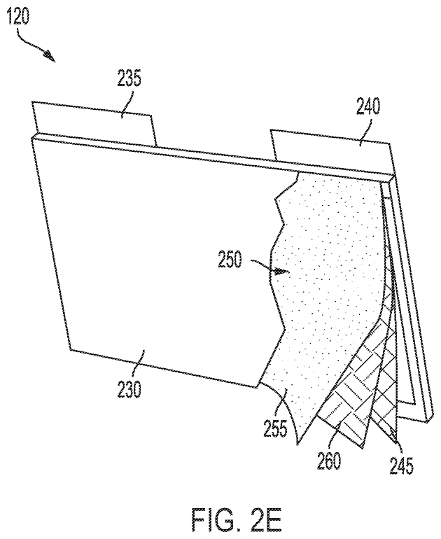

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include a lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include organic polymeric-based electrolytes or inorganic electrolytes, for example phosphide-based or Sulfide-based solid-state electrolytes (e.g., Li₃PS₄, Li₇P₃S₁₁, Li₂S—P₂S₅, Li₆PS₅Cl). Yet further, some battery cells 120 can be solid state battery cells and other battery cells 120 can include liquid electrolytes for lithium-ion battery cells.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also release lithium ions during the discharging of the battery cell 120. Conversely, the cathode layer 255 can receive electrical current into the battery cell 120 and can output electrons during the charging of the battery cell 120. The cathode layer 255 can receive lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 255) can include high-nickel content (>80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof. The ceramic electrolyte material for the electrolyte layer 260 can include, for example, lithium phosphorous oxy-nitride (LixPOyNz), lithium germanium phosphate sulfur (Li₁₀GeP₂Si₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The polymer electrolyte material (e.g., a hybrid or pseudo-solid state electrolyte) for electrolyte layer 260 can include, for example, polyacrylonitrile (PAN), polyethylene oxide (PEO), polymethyl-methacrylate (PMMA), and polyvinylidene fluoride (PVDF), among others. Whether the electrolyte layer 260 is a separator layer that can receive a liquid electrolyte (e.g., lithium ion batteries) or an electrolyte layer that can conduct ions without receiving a liquid electrolyte (e.g., solid-state batteries), the glassy electrolyte material for the electrolyte layer 260 can include, for example, lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

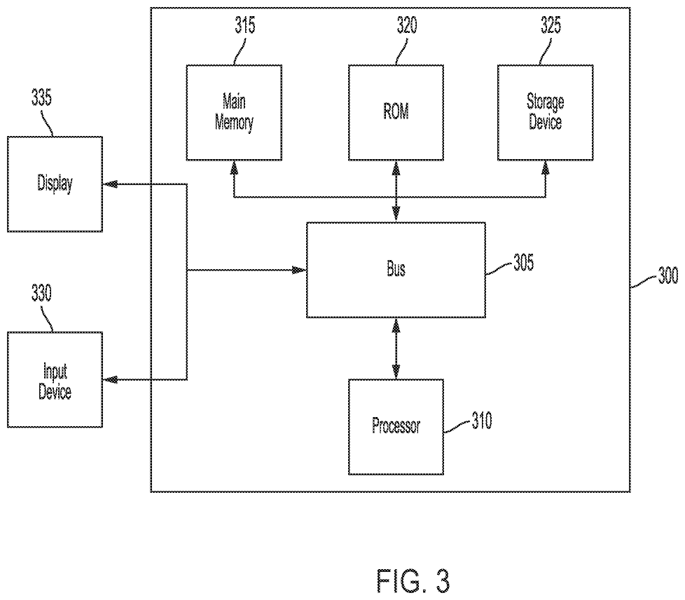

FIG. 3 depicts an example block diagram of an example computer system 300. The computer system or computing device 300 can include or be used to implement a data processing system or its components. The computing system 300 includes at least one bus 305 or other communication component for communicating information and at least one processor 310 or processing circuit coupled to the bus 305 for processing information. The computing system 300 can also include one or more processors 310 or processing circuits coupled to the bus for processing information. The computing system 300 also includes at least one main memory 315, such as a random access memory (RAM) or other dynamic storage device, coupled to the bus 305 for storing information, and instructions to be executed by the processor 310. The main memory 315 can be used for storing information during execution of instructions by the processor 310. The computing system 300 may further include at least one read only memory (ROM) 320 or other static storage device coupled to the bus 305 for storing static information and instructions for the processor 310. A storage device 325, such as a solid state device, magnetic disk or optical disk, can be coupled to the bus 305 to persistently store information and instructions.

The computing system 300 may be coupled via the bus 305 to a display 335, such as a liquid crystal display, or active matrix display, for displaying information to a user such as a driver of the electric vehicle 105 or other end user. An input device 330, such as a keyboard or voice interface may be coupled to the bus 305 for communicating information and commands to the processor 310. The input device 330 can include a touch screen display 335. The input device 330 can also include a cursor control, such as a mouse, a trackball, or cursor direction keys, for communicating direction information and command selections to the processor 310 and for controlling cursor movement on the display 335.

The processes, systems and methods described herein can be implemented by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement may also be employed to execute the instructions contained in main memory 315. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

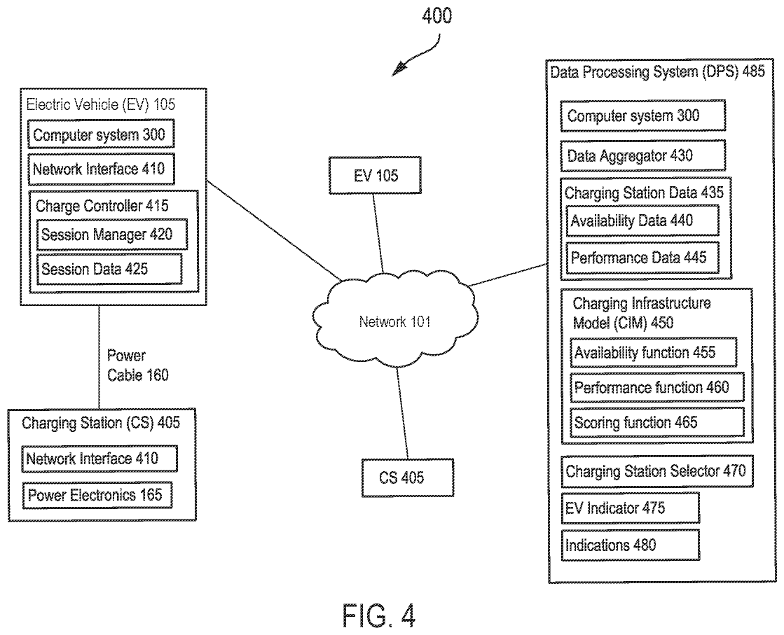

FIG. 4 depicts an example system 400 for providing an indication to an EV based on aggregated information on availability and performance of EV charging stations. FIG. 4 shows one or more EVs 105 that can communicate with one or more data processing systems (DPS) 485, via one or more networks 101. A DPS 485 can receive and aggregate data on various charging stations 405, which can also be referred to as chargers. The data received by the DPS 485 can be collected over time by EVs 105 utilizing chargers 405. Each EV 105 can include one or more computer systems 300, one or more network interfaces 410 and one or more charge controllers 415. Each charge controller 415 can include one or more session managers 420 and one or more session data 425 having data on charging stations 405 used by the EV 105. EVs 105 can gather session data 425 through various charge events in which EVs 105 can exchange communication or power with charging stations 405 during charging or discharging of the EV 105 via one or more power cables 160. Each charging station 405 can include one or more network interfaces 410 and power electronics 165 for providing bidirectional charging services to EVs 105. DPS 485 can include one or more computer systems 300, including processors 310, for processing data and one or more data aggregators 430 for aggregating data on different EV charging stations 405. DPS 485 can include one or more charging station data 435 that can include availability data 440 and performance data 445. DPS 485 can include one or more charging infrastructure models (CIMs) 450 that can include one or more availability functions 455, performance functions 460 and scoring functions 465. DPS 485 can include one or more charging station selectors 470 for selecting chargers 405 for EVs 105 to use, and one or more EV indicators 475 for issuing indications 480 to the EV 105.

Charging station (CS) 405, also referred to as a CS 405 or a charger 405, can include any combination of hardware and software for providing electricity or otherwise electrically charging or discharging one or more batteries of one or more EVs 105. CS 405 can include a bidirectional charging station and include any combination of hardware and software for providing power to or drawing power from one or more batteries of the EV 105, such as the battery packs 110, battery modules 115 or battery cells 120. CS 405 can include scripts, functions and computer code stored in memory and executed or operating on one or more processors to implement any functionality of the CS 405. For example, CS 405 can include a computer system 300 having one or more processors 310 and memories 315, 320 and 325, each of which can store computer code, scripts, functions and instructions to implement functionality of CS 405. CS 405 can include electrical and power circuitry, control logic or circuits, power electronics, power supply circuitry, energy storage devices, such as batteries, and other hardware for storing, controlling, modulating or otherwise managing power, energy or electricity provided to, or drawn from, EVs 105. CS 405 can include electric vehicle charging equipment that can include a power and control box and power cord or a cable 160. CS 405 can include circuitry for converting alternating current (AC) to direct current (DC), such as an AC-DC converter. CS 405 can include DC-AC converters or DC-DC converters.

Charging station 405 can be electrically coupled to an electrical grid and can draw electricity from the grid to charge EVs 105, as well as receive electricity from the batteries (e.g., 110, 115 or 120) of the EV 105 and provide this electricity to the electrical grid. Charging station 405 can be set to operate, including provide or draw electricity, at any voltage, current or power level, such as levels rated for level-1, level-2 or level-3 chargers. For example, CS 405 can provide electricity to EVs or draw power from EVs 105 at any voltage level, such as 120V, 208-240V or 400-900V. Similarly, CS 405 can provide electricity to EVs 105 or draw electricity from EVs 105 at any power levels, which can be included in level 1, level 2 or level 3 chargers, covering anywhere between 5 kW and 800 kW, including for example: 5 kW, 10 kW, 20 kW, 30 kW, 50 kW, 80 kW, 100 kW, 150 kW, 220 kW, 250 kW, 300 kW, 350 kW, 500 kW, or more.

For example, a charging station 405 can be configured to provide services at a particular rating, and be rated at a particular voltage, power or current level or range. A charger 405 can be a level 1 charger and can operate at around 110-120V and between about 1.3 kW and 2.4 kW, corresponding to about 10 A to 20 A of current range. For example, a level 2 rated charging station 405 can operate at around 208V-240V and about 3 kW to 19 kW range, which can correspond to about 12 A to 90 A of current range. For example, level 3 rated charging station 405 can operate at around 400V-900V and about 50 kW to 350 kW, which can correspond to about 55 A to 875 A of current range. Charging stations 405 can be therefore rated at particular power, voltage or current ranges or levels. Charging stations 405 can provide their power at a particular power, voltage or current range or level that is at the rated level, above the rated level or below the rated level. Charging stations 405 can communicate the rated levels with EVs 105 via network interfaces 410, such as via a network 101.

Power electronics 165 can include any component, part, subsystem or system of the CS 405 used to provide charging or discharging services to EVs. Power electronics 165 can include circuits, components or parts providing power to EVs 105 or receiving power from EVs 105. Power electronics 165 can include one or more control boxes, including power circuitry, control electronics, controllers and circuits for managing power or communication between a CS 405 and an EV 105 via a power cable 160. Power electronics 165 can include any analog and digital circuitry, including for example, AC-DC converters, DC-DC converters, DC-AC converters, any combination of power transistors, capacitors, inductors, resistors, diodes, switches, transformers, relays and other electrical or electronic components to form structures, such as half and full bridge circuits, rectifiers, filters, multi-function circuits, single or multi-stage chargers with resonant half-bridge converts utilizing one or more inductors and one or more capacitors, such as the LLC converters and single or multi-directional DC-DC converters. Power electronics 165 can be controller or managed by processors, such as processors 310. Power electronics 165 can include or be connected to memory, such as 315, 320 or 325, which can store scripts, computer code or instructions to be accessed or executed by electronic microcontrollers or devices, such as processors 310. Power electronics 165 can include one or more energy storage systems, including batteries for storing energy, as well as circuitry for interfacing with the electrical grid.

Power cable 160, also referred to as the power cord 160, can be attached to or coupled with power electronics 165 of a charging station 405. Power cable 160 can include one or more electrical conductor wires or lines, including lines or wires for high power throughput as well as electronic or electrical signals. Power cable 160 can include or be connected to a power plug for plugging into an EV 105 and can include wires or lines for conducting high power, high voltage or high current between EV 105 and CS 405. Power cable 160 can include one or more wires or lines for conducting analog or digital communication signals between the EV 105 and CS 405. Power cable 160 can facilitate or provide a conduit or path for exchange of communication between EV 105 and a charger 405 and for exchange of power (e.g., electricity) between EV 105 and the charger.

A computer system 300 can be included within or connected to an EV 105, a CS 405 or a DPSs 485. A computer system 300 can be deployed at a cloud or a VPN infrastructure. For example, a cloud service provided by one or more servers on a network 101 can implement or comprise the functionality or components of the computer system 300. Computer system 300 can include any number of processors 310 and memories, such as one or more main memories 315, ROMs 320 or storage devices 325. Processors 310 can run or execute instructions that can be stored in the memory devices (e.g., main memories 315, ROMs 320 or storage devices 325) in order to implement the functionalities of the present solution. For example, one or more processors 310 can be located on and execute instructions on a EVs 105, a DPSs 485 or a CS 405.

Network interface 410 can include any combination of hardware and software for communicating via a network 101. Network interface 410 can include scripts, functions and computer code stored in memory and executed or operating on one or more processors to implement any network interfacing, such as network communication via a network 101. Network 101 can include any wired or wireless network, a world wide web, a local area network, a wide area network, a wifi network, a Bluetooth network or any other communication network or platform. Network interface 410 can include functionality for communicating, via network 101, using any network communication protocol such as Transmission Control Protocol (TCP)/Internet Protocol (IP), user datagram protocol (UDP), or any other communication protocol used for communicating over a network 101. Network interface 410 can include communication ports and hardware for receiving and sending data and messages over the network 101 or via a power cable 160. Network interface 410 can include the functionality to encode and decode, send and receive any information, commands, instructions, data structures, values or other data between the EV 105 and CS 405. Network interface 410 can include the functionality to transmit between the EV 105 communications for establishing, managing and maintaining a charging session between the EV 105 and CS 405 and exchange data for the session.

Network interface 410 can include any combination of hardware and software for communicating via power cable 160. Network interface 410 can include scripts, functions and computer code stored in memory and executed or operating on one or more processors to communicate via a power cable 160. For example, network interface 410 can include the functionality to communicate via one or more wires or lines for communication via the power cable 160. Network interface 410 can include the functionality, including circuitry, processors and memory, to send, analog or digital communication between the EV 105 and charger 405, via one or more lines in the power cable 160.

Charge controller 415 can include any combination of hardware and software for controlling or managing charge or amount of power provided to EV 105. Charge controller 415 can include scripts, functions and computer code stored in memory and executed or operating on one or more processors to implement any functionality of the charge controller 415. Charge controller 415 can set, control or monitor a rate of charge to provide to EV 105 or draw from an EV 105. Charge controller 415 can set or monitor a power level, a voltage level or a current level for a charge event. Charge controller 415 can set up, manage, maintain and monitor sessions to acquire session data 425 using a session monitor 420.

Charge controller 415 can send negotiate a charging or discharging session with a CS 405 and exchange communication to request a particular rated performance or level of service (e.g., charging or discharging) to be provided to EV 105. Charge controller 415 can request a rate of charge or power level to be provided to the EV 105 via a power cable between the CS 405 and EV 105. Charge controller 415 can receive a different rate of charge or power level than the one requested. Charge controller 415 can monitor the rate of charge or power provided to, or drawn from, the EV 105. Session manager 420 can store the rated performance level of the charger and the actual performance level of the CS 405 measured or monitored by the session manager 420, such as any one or more of the power level, current level or voltage level of the CS 405.

Session Manager 420 can include any combination of hardware and software for managing sessions between EVs 105 and CSs 405 and acquire session data 425. Session manager 420 can include scripts, functions and computer code stored in memory and executed or operating on one or more processors to establish, manage and monitor a charging or discharging session with an EV 105 and acquiring session data 425. Session manager 420 can communicate with EV 105 to set, establish, monitor or maintain the session data 425. Session manager 420 can detect, measure and monitor power, voltage or current rated for the CS 405 as well as the actual power, voltage or current that was received from or delivered to EV 105. Session manager 420 can include the functionality to store CS 405 information into session data 425, including information on any attempted session, failed session, number of attempts to create a session before the session is successfully established, number of failed session attempts, any session errors, power interruptions, deviations of the power provided or drawn to the power rated or any other information for the session.

Session data 425 can include any data on any charge even session between EV 105 and a CS 405. Session data 425 can include any information on the CS 405 or the EV 105 corresponding to a charge event. For example, session data 425 can include any information on the CS 405, including CS 405 identification name, number or code, a network communication address of the CS 405, a network unique identifier of CS 405, a location of CS 405 or a physical address of the CS 405. Session data 425 can include any information on the power level or power rated for the CS 405, such as whether CS 405 is a level 1 charger, a level 2 charger, or a level 3 charger. Session data 425 can include information on the communication between EV 105 and charger 405 to establish a charging or discharging session, including any number of attempts to establish a session and whether they were successful or not, any broken sessions, any errors or warnings for the sessions or any other session data. Session data 425 can include information of the EV 105, such as EV 105 license plate, vehicle identification number, network communication identifier, EV driver name and address, an account number corresponding to the EV 105 or any other information on the EV 105.

Session data 425 can include any communication or power related information corresponding to any charging or discharging event between an EV 105 and a charger 405. For example, session data 425 can include a location, date and time, or a timestamp of the charge event. Session data 425 can include information on the type of the charge event, such as whether it was EV 105 being charged or discharged, or level of the charger 405 involved, such as level 1, level 2 or level 3 charger. Session data 425 can include information on the session, such as a date, location or a timestamp of any communication between the EV 105 and CS 405, a time of an attempt to establish a session between the CS 405 and the EV 105, a time of termination of the session, or a time of any error or warning. Session data 425 can include information on whether one or more attempts to establish a session with a particular charger 405 at a particular time was successful or not successful and any data on whether the charger 405 was operable or not operable. Session data 425 can include notifications about the state of charge of the battery pack 110 at a particular time, rate of discharge of the EV 105, location of the EV 105, distance between the EV 105 and a CS 405, information about EV driver 105 or any other information related to EV 105. Session data 425 can include data on the characteristics of the power, current or voltage measured by the EV 105. For example, session data 425 can include power, current or voltage measurements as the EV 105 was receiving electricity from a charger 405 during a charge event. For example, session data 425 can include power, current or voltage measurements as the EV 105 was transmitting or sending electricity to a charger 405 during a discharge event. Session data 425 can include any information on the ratio between the power, current or voltage level for which the CS 405 is rated and the power, current or voltage level which the EV 105 has detected being drawn from and provided to the CS 405 by the EV 105. Session data 425 can include time duration of the session of a charge or discharge event, time duration in which the CS 405 was operating at rated power level, time duration in which CS 405 was operating outside of, or at a level that is less than, the rated power level and the power level at which the CS 405 was operating (e.g., charging and discharging).

Data aggregator 430 can include any combination of hardware and software for receiving session data 425 from EVs 105 and aggregating received data for storage as charging station data 435. Data aggregator 430 can receive session data 425 from any number of EVs 105 and store the session data 425 into one or more main memories 315, ROMs 320 or storage devices 325. Data aggregator 430 can store data into data structures which can include tables or lists organizing data based on individual charge events, charge stations 405 used or time periods. Data aggregator 430 can manage the aggregated data and provide stored data to charging infrastructure model 450 for processing.

Data processing system (DPS) 485 can include any combination of hardware and software for providing to an electric vehicle an indication of a charging station based on, or including, updated information on availability and performance of the charging stations. DPS 485 can include processors 310 processing instructions stored in memories, such as main memory 315, ROM 320 or storage device 325, to implement actions or functionalities of the DPS 485. DPS 485 can receive, via network 101, data, such as session data 425 from any number of EVs 105. DPS 485 can store session data 425 from the EVs 105 as charging stations data 435 into a database that can be stored on a memory, such as main memory 315, ROM 320 or storage device 325. DPS 485 can implement the functionality to determine availability and performance of the each CS 405.

DPS 485 can comprise the functionality to score the CSs 405 using the availability and performance of the CSs 405 and rank the CSs 405 based on their scores. DPS 485 can include the functionality to receive notifications that an EV 105 is running out of battery charge and is going to use a CS 405 to charge. DPS 485 can include the functionality to respond to the notification with an indication of one or more CSs 405 for the EV 105 to use. DPS 485 can include the functionality to use the location of the EV 105 to select one or more CSs 405 with highest scores in the area or location in which EV 105 is located and send to the EV 105, or its driver, an indication of the one or more selected CSs 405.

DPS 485 can include can operate on a remote server, a server farm, a virtual machine or a cloud computing system comprising one or more servers or located at a data center. DPS 485 can include, utilize, execute on or be coupled to a computer system 300, including processors 310 be coupled with memories (e.g., main memories 315, ROMs 320 or storage devices 325). Each of the memories can store for the DPS 485 the computer code, scripts, functions and instructions to implement any functionality of the DPS 485. For example, DPS 485 can include scripts, functions and computer code stored in memory and executed or operating on one or more processors 310 to receive data from EVs 105 and parse and process received data to identify availability data 440 and performance data 445 for each CS 405. DPS 485 can operate a charging infrastructure model 450, which can determine availability and performance of each CS 405 and use a scoring function 465 to score any number of CS 405 based on their availability and performance. DPS 485 can select for any EV 105 one or more EVs 105 to use and use EV indicator 475 to provide indications 480 of the selected CSs 405 to the EV 105.

Charging station data 435, also referred to as the CS data 435, can include any collection of data from one or more charging stations 405. CS data 435 can include data from a single CS 405 or a plurality CSs 405 and include data about CSs 405 manufactured by a single manufacturer or CSs 405 manufactured by various manufacturers. CS data 435 can include any session data 425 from any number of EVs 105, as well as any information from CSs 405 received over a network 101. CS data 435 can include availability data 440, performance data 445 and any other data that can be used for determining availability and performance of CS 405. CS data 435 can be acquired via network 101 or via power cable 160. CS data 435 can be stored in one or more data structures or databases. For example, CS data 435 can be stored in a database that can include a data structure for each one of the CSs 405. The data structure can include availability data 440 and performance data 445 of the CS 405, along with any determinations or scores corresponding to CS 405, made by charging infrastructure model 450.

Availability data 440 can include any information identifying, describing or corresponding to availability of a CS 405 to provide service to EVs 105. Availability data 440 can include information received by EV 105 via a power cable 160 connected to a CS 405 or received via a network 101. Availability data 440 can include data generated by the EV 105, such as data from EV 105 sensors. Availability data 440 can include information identifying whether or not a CS 405 is operable, powered up, functional or otherwise available for providing service to EVs 105. For example, charging station data 435 can include information that a charging station 405 is powered off or otherwise out of service. CS data 435 can include information that a CS 405 is avoided by one or more EVs 105. For example, CS data 435 can include information that one or more EVs 105 attempted to use the CS 405 and were unable to form a session or use the CS 405. Availability data 440 can include data corresponding to EV 105 moving past a particular CS 405 or avoiding a particular CS 405 and instead using another CS 405 for charging or discharging. Availability data 440 can include location data, such as a global positioning system (GPS) data of an EV 105, timing of an event, such as EV 105 passing by and not using a CS 405 or using stopping at and using the CS 405, attempting to establish a session with the CS 405, establishing the session with CS 405 or failing to establish the session.

Performance data 445 can include any information identifying, describing or corresponding to the performance of the CS 405. Performance data 445 can include information received via power cable 160. Performance data 445 can include information corresponding to the power, voltage, current, phase or any other characteristic of the charge provided by the EV 105 or received by the EV 105. Performance data 445 can include information corresponding to power, voltage, current or phase over a time period or at various points in time. Performance data 445 can include information on the percentage of power transmitted via power cable 160 with respect to the maximum power transfer capacity, such as defined by the rated performance for the CS 405. For example, a CS 405 can be or include a level 3 charger that is rated to provide power at 350 kW. Performance data 445 can include information for this CS 405 that it provides power at 250 kW instead of 350 kW rated power. Performance data 445 can correspond to or include a ratio of the power provided to the EV 105 (e.g., 250 kW) and the power rated (e.g., 350 kW), such as for example 250 kW/350 k/W, which can be described in terms of the percentage of the rated performance of the CS 405, such as 71.4% of the rated power.

Charging Infrastructure Model (CIM) 450 can include any combination of hardware and software, such as scripts, functions and computer code stored in memory or operating on a processor for performing any functionality of CIM 450. CIM 450 can include functionality for calculating or determining availability and performance of CSs 405 from the availability data 440 and performance data 445. CIM 450 can include functionality to score and rank all of the CSs 405 based on the determined availability and performance. CIM 450 can include functionality or programming code for identifying availability data 440 and performance data 445 from charging station data 435. CIM 450 can include functionality for calculating, determining or modeling availability, performance or scores of any CS 405. CIM 450 can determine or calculate availability, performance or scores for any CS 405 of a plurality of CSs 405 in a geographical area, or a region, such as for example a town, a county, a state, a country or multiple countries. CIM 450 can determine or calculate a score for any CIM 450. CIM 450 can compare scores between different CSs 405 to identify those with highest scores in a particular geographical region or a region defined by a distance from an EV 105. CIM 450 can include the functionality to receive updated data, based on which CIM 450 can update the availability and the performance of any CS 405, and any score of the CS 405 based on the updated availability and performance.

CIM 450 can include and utilize one or more machine learning (ML) or artificial intelligence (AI) functions to determine availability, performance or scoring of one or more CSs 405. CIM 450 can include a ML functionality model trainer having any combination of hardware and software, including scripts, functions and computer code stored in memory or operating on a processor for training one or more availability functions 455, performance functions 460 or scoring functions 465. CIM 450 can include an ML model trainer to train availability function 455 to use charging station data 435 as input and provide availability data 440 as output. CIM 450 can include an ML model trainer to train availability function 455 to use charging station data 435 as input and determine availability of each one of the CSs 405 as output. Determined availability can be used for scoring or ranking CSs 405 and can be stored in availability data 440. CIM 450 can include an ML model trainer to train performance function 460 to use charging station data 435 as input and provide performance data 445 as output. CIM 450 can include an ML model trainer to train performance function 460 to use charging station data 435 as input and determine performance of each one of the CSs 405 as output. Determined performance can be used for scoring or ranking CSs 405 and can be stored in performance data 445. CIM 450 can include an ML model trainer to train scoring function 465 to use availability data 440 determined by availability function 455 and performance data of one or more CSs 405 determined by performance function 460 to determine and provide scores of the one or more CISs 405 as outputs.

CIM 450 can include any functionality to generate or train the availability function 455, performance function 460 or scoring function 465. CIM 450 can perform the training using any ML or Al function or technique, such as, for example, supervised learning, unsupervised learning, or reinforcement learning. CIM 450 can include a model trainer that can include or use functions such as linear regression, logistic regression, a decision tree, support vector machine, Naïve Bayes, k-nearest neighbor, k-means, random forest, dimensionality reduction function, or gradient boosting functions.

Availability function 455 can include any combination of hardware and software, such as scripts, functions and computer code stored in memory or operating on a processor for determining availability of a CS 405. Availability function 455 can monitor or analyze charging station data 435 and identify availability data 440. Availability function 455 can parse CS data 435 and identify data pertaining to availability of a CS 405. For example, availability function 455 can identify in charging station data 435 one or more information indicating that one or more EVs 105 have passed by, or avoided using, a CS 405, while stopping at another CS 405 and using that other CS 405 for service. Availability function 455 can mark or identify this one or more information as availability data 440. For example, availability function 455 can identify in CS data 435 that a CS 405 is marked as nonoperational or out of service, or that one or more EVs 105 were unsuccessful in establishing session with or using the CS 405. Based on identified availability data 440, availability function 455 can determine that such a particular CS 405 is unavailable or nonoperational. For example, availability function 455 can determine that a CS 405 is operational based on CS data 435 identifying or indicating that one or more EVs 105 have successfully connected to, established session with and successfully completed a charge or discharge event at the CS 405.

Availability function 455 can make such a determination on availability of CSs 405 using for example a rule based model of the availability function 455. For example, availability function 455 can include rules to identify availability data 440 from the CS data 435 or determine whether a particular CS 405 is available or unavailable using the availability data 440 that the availability function 455 has identified for a particular CS 405. Availability function 455 can make determinations using a ML or Al based model of the availability function 455. For example, availability function 455 can include ML or Al model which can use as input CS data 435 to provide as output availability data 440 for one or more CSs 405. Availability data 440 can include data organized per each individual CS 405, such that availability data 440 for each CS 405 is identified and stored in a data structure of a database that can store all availability data 440 for all CSs 405. Availability function 455 can weigh different types of availability data 440 based on weights for each availability data. For example, more recent data can be weighed higher than less recent data, data on successful or unsuccessful attempts to establish a session with a charger 405 via power cable 160 can be weighed more than GPS data indicating that one or more EVs 105 avoid using the charger 405. Availability function 455 can include ML or Al model to use availability data 440 as input to provide a score for the CS 405 as output. The output score can include availability score for one or more CSs 405.

Performance function 460 can include any combination of hardware and software, such as scripts, functions and computer code stored in memory or operating on a processor for determining performance of a CS 405. Performance function 460 can monitor or analyze charging station data 435 and identify performance data 445 for any CS 405. Performance function 460 can parse CS data 435 and identify data pertaining to the performance of a CS 405, which can include, for example: any one or more of measured power, voltage or current of a CS 405 provided to or drawn from an EV 105, an amount or percentage of time during a charging session when a CS 405 operated at a rated level for power, current or voltage, an amount or percentage of time during a charging session when a CS 405 operated below the rated level for power, current or voltage for the CS 405, a ratio of the measured power, current or voltage provided to or drawn from an EV 105 and the rated power, current or voltage levels for the CS 405, an amount or a percentage of time when a session was successfully established with respect to the total number of times when the sessions with the CS 405 were attempted, or a number of attempts used to establish a session with a CS 405. Performance function 460 can determine the performance of the CS 405 using, for example, a rule based model of the performance function 460 or a ML or Al based model of the performance function 460. For example, performance function 460 can include rules to identify performance data 445 from the CS data 435 and determine actual measured performance of a CS 405 from the performance data 445 for a particular CS 405. For example, performance function 460 can include ML or Al model which can use as input CS data 435 to provide as output performance data 445 for one or more CSs 405. Performance function 460 can include data organized per each individual CS 405, such as performance data 445 for each CS 405 identified and stored in a data structure of a database that can store all performance data 445 for all CSs 405. Performance function 460 can weigh different types of performance data 445 based on weights for each performance data 440. For example, more recent data can be weighed higher than less recent data, data on successful or unsuccessful attempts to establish a session with a charger 405 via power cable 160 can be weighed more than GPS data indicating that one or more EVs 105 avoid using the charger 405. Performance function 460 can include ML or Al model to use performance data 445 as input to provide a score for the CS 405 as output. The output score can include performance score for one or more CSs 405.

Scoring function 465 any combination of hardware and software, such as scripts, functions and computer code stored in memory or operating on a processor for determining a score for one or more CSs 405. Scoring function 465 can determine a score for a CS 405 based on availability data 440, performance data 445 and a combination of availability data 440 and performance data 445. Scoring function 465 can determine the score using a rule-based model of the scoring function 465. For example, a scoring function 465 can use rules to weigh different performance data 445 or weight different availability data 440 to determine a score for a CS 405. Scoring function 465 can determine the score using a ML or Al model of the scoring function 465. For example, a scoring function 465 can use performance data 445 as input into a ML or Al model or use availability data 440 as input into the same or different ML model of the scoring function to output a score for a CS 405. Scores for each of the CSs 405 can be stored into data structures of database of the DPS 485.

Charging Station Selector 470 can include any combination of hardware and software for selecting CSs 405 to be identified in the indications 480 sent to an EV 105. Charging station selector 470 can include the functionality for identifying which CSs 405 are most suitable to service an EV 105. Charging station selector 470 can select one or more CSs 405 in response to a notification from an EV 105. For example, charging station selector 470 can receive a notification of a location of an EV 105 that is going to soon have its battery charged. Charging station selector 470 can include the functionality to determine locations of closest CSs 405 for the EV 105, based on the EV 105 location and the amount of remaining charge of the EV 105. For example, a DPS 485 can receive a GPS location of an EV 105, and based on the location of the EV 105 or the amount of charge remaining, DPS 485 can use the charging station selector 470 to identify one or more CSs 405 within a threshold distance from the EV 105. The threshold distance can be a distance that EV 105 can travel in order to reach the CS 405 to get recharged, given its current state of charge, such as for example anywhere between 0 and 20 miles. For example, an EV 105 can be within any range of one or more CSs 405, such as 1 mile, 2 miles, 5 miles, 10 miles, 15 miles or 20 miles from a CS 405, any one of which can be set up as the threshold distance. The threshold distance can be determined or established based on the remaining charge on the EV 105. For example, a threshold distance can be set to 20 miles when there is sufficient charge on the EV 105 for a 20 mile trip. The threshold distance can be set to 5 miles in response to the EV 105 having sufficient charge for a 5 mile trip, or can be set to a multiple of that 5 mile distance, such as 1.5 times or 2 times that distance. Charging station selector 470 can make selections of the CSs 405 for an EV 105, responsive to a received notification from an EV 105. The notification can state, for example, that an EV 105 is seeking a CS 405, that EV 105 has less than a particular threshold amount of charge remaining or that EV 105 is at a particular location or area.

Charging station selector 470 can select the highest scored one or more CSs 405 out of all CSs 405 within a threshold distance from the EV 105 and send their information to EV indicator 475 to be indicated to EV 105. Charging station selector 470 can prioritize CSs 405 that are closer to the EV 105 over those CSs 405 that are further away. For example, when a charging station selector 470 identifies multiple CSs 405 that are at a same distance, within a tolerance range, from the EV 105, then the charging station selector 470 can select for an EV 105 the CS 405 that has a higher score. For example, when a charging station selector 470 identifies multiple CSs 405 that have a same score, within a tolerance range, with respect to each other, the charging station selector 470 can select for the EV 105 the CS 405 that is closer to the EV 105. Charging station 470 can output the select one or more CSs 405 and provide the output to the EV indicator 475 to use for indications 480 to EV 105.

EV indicator 475 can include any combination of hardware and software for sending indications to EV 105. EV indicator 475 can receive output from the charging station selector 470 and use the output to produce indications 480 for the EV 105. EV indicator 475 can include the functionality to create a dispatch or a transmission for an EV 105 (e.g., an indication 480) to indicate to the EV 105 one or more CSs 405 that are recommended for the EV 105 to use, based on their availability and performance determined by the CIM 450. EV indicator 475 can work with network interface 410 to transmit the indications 480 to the EV 105.

EV indications 480 can include any one or more transmissions or message from the DPS 485 to an EV 105. EV indication 480 can be transmitted to an EV 105, responsive to a request to DPS 485 from an EV 105, or a driver of the EV 105, for a recommendation for CSs 405 for the EV 105 to use. EV indication 480 can include any one or more information identifying one or more CSs 405, their locations, addresses or links to directions to the CS 405, the score of the one or more CSs 405, as well as their availability or performance as determined by CIM 450. EV indication 480 can identify that CS 405 is available and its availability data. EV indication 480 can identify performance of the CS 405 including the power, voltage or current provided by the CS 405, the rated power level of the CS 405 and information corresponding to past experiences of other EVs 105 that have used that CS 405.

The present solution can include a system 400 for providing an indication 480 to an EV 105 based on, or including, information on availability and performance of charging stations 405. System 400 can include a data processing system 485 that can include one or more processors 310 coupled with memory, such as any number of main memories 315, ROMs 320 or storage devices 325. One or more processors 310 can execute the instructions to perform or implement various functionalities of the DPS 485. For example, DPS 485 can receive, from a plurality of EVs 105, data on a plurality of charging stations 405. The received data can include session data 425 from the plurality of EVs 105, which can be compiled into charging station data 435. The data, such as charging station data 435, can include first data (e.g., availability data 440) corresponding to availability of the plurality of charging stations and second data (e.g., performance data 445) corresponding to performance of the plurality of charging stations 405 captured by the plurality of electric vehicles 105 via a plurality of power cables 160 that couple the plurality of electric vehicles 105 with the plurality of charging stations 405. DPS 485 can determine, based on the data (e.g., CS data 435 or availability data 440), availability of a charging station of the plurality of charging stations. DPS 485 can determine, based on the data (e.g., CS data 435 or performance data 445) captured via a power cable 160 of the plurality of power cables 160, performance of the charging station 405. DPS 485 can generate, based on the availability and the performance, a score for the charging station 405. DPS 485 can provide, based on a comparison of the score for the charging station 405 with a second score for a second charging station 405 of the plurality of charging stations 405, an indication 480 corresponding to the charging station 405.

Data processing system 485 can receive, from one or more electric vehicles 105 of the plurality of electric vehicles 105, the data (e.g., session data 425, charging station data 435) comprising information on whether the charging station 405 provided service to the one or more electric vehicles 105. DPS 485 can determine, based on the information, the availability for the charging station 405. For example, DPS 485 can receive from an EV 105 information that the EV 105 has used the charging station 405 for charging EV 105. In response to the information, DPS 485 can determine that the CS 405 is available. For example, DPS 485 can receive from an EV 105 information that EV 105 has not been used by any of the plurality of EVs 105 for which data (e.g., CS data 435) was received over a time period (e.g., a recent day, several days, week, several weeks or longer). In response to the information, DPS 485 can determine that the CS 405 is not available.

Data processing system 485 can receive, from one or more electric vehicles 105 of the plurality of electric vehicles 105, the data (e.g., CS data 435, session data 425) comprising information corresponding to the one or more electric vehicles 105 using one or more charging stations 405 of the plurality of charging stations 405 instead of the second charging station 405. DPS 485 can determine, based on the information, the availability for the second charging station 405. For example, DPS 485 can receive information that a plurality of EVs 105 have not stopped by and used the second CS 405, but instead had utilize the first station 405. DPS 485 can determine, in response to this information, that EVs 105 are avoiding usage of the second charging station 405.

Data processing system 485 can receive, from one or more electric vehicles 105 of the plurality of electric vehicles, the data (e.g., CS data 435, session data 425) comprising information corresponding to one or more charging events by the one or more electric vehicles 105 with the charging station 405. DPS 485 can determine, based on the information, one of the availability or the performance of the charging station. For example, DPS 485 can determine, from session data 425 of a charging event with the charging station 405, that the charging station 405 is available. DPS 485 can determine, from the same data, performance of the CS 405, including the power, current or voltage ranges at which the CS 405 operates, the power, current or voltage ranges at which the CS 405 is rated, and the difference between the measured power current or voltage at which the CS 405 operates with respect to the rated power, current and voltage.

Data processing system 485 can receive, from one or more electric vehicles 105 of the plurality of electric vehicles, the data (e.g., CS data 435, session data 425) comprising information on an amount of power throughput between the charging station 405 and the one or more electric vehicles 105. DPS 485 can determine, based on the information, the performance of the charging station 405. DPS 485 can receive, from one or more electric vehicles 105 of the plurality of electric vehicles, the data (e.g., 425, 435) comprising information on a measured amount of power throughput between the charging station 405 and the one or more electric vehicles 105 and a rated amount of power throughput between the charging station 405 and the one or more electric vehicles 105. DPS 485 can determine, based on a ratio of the measured amount of power throughput and the rated amount of power throughput, performance of the charging station 405.

Data processing system 485 can identify that the charging station 405 is within a threshold distance from the electric vehicle 105. The threshold distance can be any distance, such as 1 mile, 2 miles, 4 miles, 6 miles, 8 miles or 10 miles. The threshold distance can be determined by the DPS 485 based on the location of the EV 105 (e.g., whether it is in a densely or sparsely populated are) or the amount of battery charge remaining on the EV 105 (e.g., sufficient for 5 miles, 10 miles, 15 miles or more). DPS 485 can identify that the second charging station 405 is within the threshold distance from the electric vehicle 105. DPS 485 can provide, to the electric vehicle 105 responsive to the identification, the indication 480 corresponding to the availability and performance of the charging station 405 and the second charging station 405.

Data processing system 485 can receive, from an electric vehicle 105, a notification that a charge level of the electric vehicle 105 is below a threshold. The threshold for the EV 105 charge level can be a percentage of battery charge remaining, such as up to 5%, 10%, 15% or 20%. The threshold for the EV 105 charge level can be an amount of distance that the EV 105 can cover with the remaining amount of charge, such as up to 5 miles, 10 miles or 20 miles. DPS 485 can identify that the charging station 405 is within a threshold distance from the electric vehicle. The threshold distance can be a distance of, for example, up to 2 miles, 5 miles, 10 miles or more. DPS 485 can provide, to the electric vehicle 105, responsive to the identification and the notification, the indication 480 corresponding to the charging station 405.

Data processing system 485 can receive, from an electric vehicle 105, a notification that the electric vehicle 105 is to be charged. DPS 485 can identify that the charging station 405 and the second charging station 405 are within a threshold distance from a path that the electric vehicle is going to travel. For example, DPS 485 can receive the notification identifying a path from a first location to a second location through which the EV 105 is going to travel. The notification can identify one or more CSs 405 within a threshold distance (e.g., up to 1 mile, 2 miles or 5 miles) from the path that the EV 105 is going to travel. DPS 485 can provide, responsive to the identification, the indication corresponding to the availability and the performance of the charging station 405 and the second charging station 405.

Data processing system 485 can identify that the charging station 405 and the second charging station 405 are within a threshold distance of the electric vehicle 105. DPS 485 can provide, to a mobile application, the indication 480 corresponding to the charging station 405. The indication 480 can be provided responsive to a notification from the mobile application of the driver of the EV 105. The request may be for a recommendation for a CS 405 for the EV driver of the EV 105 to use.

Data processing system 485 can receive, from one or more electric vehicles 105 of the plurality of electric vehicles 105, updated data (e.g., session data 425) corresponding to the first charging station 405 and the second charging station 405. DPS 485 determine, based on the updated data, updated availability and updated performance of each of the first charging station and the second charging station. DPS 485 can generate, based on the updated availability and updated performance, updated score for the charging station and a second updated score for the second charging station. DPS 485 can provide, in response to the updated score and the second updated score, an updated indication 480 corresponding to one of the charging station 405 or the second charging station 405.

System 400 can include a data processing system 485 that can include one or more processors 310 coupled with memory, such as main memory 315, ROMs 320 or storage device 325. System 400 can include a non-transitory computer-readable medium (e.g., 315, 320, 325) storing instructions, which when executed by at processor 310, cause the processor 310 to implement tasks or functionalities of the data processing system 485. For example, data processing system 485 can receive, from a first electric vehicle 105, data regarding a first charging station 405 (e.g., charging station data 435, session data 425). The data regarding the first charging station 405 can include at least one of data corresponding to performance of the first charging station (e.g., performance data 445) captured by the first electric vehicle 105 via a power cable 160 that couples the first electric vehicle 105 with the first charging station 405 and data corresponding to availability (e.g., availability data 440) of the first charging station 405.

Data processing system 485 can receive, from a second electric vehicle 105, data regarding a second charging station 405 (e.g., charging station data 435, session data 425). The data regarding the second charging station 405 can include at least one of data corresponding to performance of the second charging station (e.g., performance data 445) captured by the second electric vehicle 105 via a power cable 160 that couples the second electric vehicle 105 with the second charging station 405 and data corresponding to availability (e.g., availability data 440) of the second charging station 405.

Data regarding the first charging station 405 or the second charging station 405 can be received from a plurality EVs 105. The plurality of EVs 105 can interact or use the first and second charging stations 405. If one of the first or the second charging stations 405 is unavailable, the plurality of EVs 105 can pass by, not stop at, or avoid the unavailable charging station 405, and instead use another charging station 405 that is available.

Data processing system 485 can determine, based on the data (e.g., 435, 425) regarding the first charging station 405 and the data (e.g., charging station data 435, session data 425) regarding the second charging station 405, availability of at least one of the first charging station 405 and the second charging station 405. DPS 485 can determine the availability of the first or the second charging station 405 based on data (e.g., 435, 425) comprising information on the charging sessions of one or more EVs 105 that have used the first or the second charging station 405 within a recent time frame, such as within the last hour, within the last 6, 9, 12, 18 or 24 hours, within the last two or three days, within the last week, or within the last month. DPS 485 can determine that one of the first or the second charging station 405 is unavailable in response to a plurality of EVs 105 passing by, not stopping at, or avoiding this charging station 405.

Data processing system 485 can determine, based on at least one of the data corresponding to performance (e.g., performance data 445) of the first charging station 405 and the data corresponding to performance (e.g., performance data 445) of the second charging station 405, performance of at least one of the first charging station 405 and the second charging station 405. DPS 485 can determine the performance of the first or the second charging station 405 based on data 445 on the amount of power transmitted between the charging station 405 and one or more electric vehicles 105 that have used the charging station 405. DPS 485 can determine the performance data 445 indicating or corresponding to a ratio of the power provided by the charging station 405 and the power rated for the charging station. DPS 485 can determine the performance based on a time duration during which the charging station 405 operated at a maximum rated power level. DPS 485 can determine the performance based on a ratio of the time during which the charging station 405 operated at the maximum rated power level for the charging station 405 and the total mount of time during which the charging station 405 was operating. The performance can be based on the percentage of time during which the charging station 405 operated at the maximum power level with respect to its total operational time.

Data processing system 485 can generate, based on the availability of at least one of the first charging station 405 and the second charging station 405 and the performance of at least one of the first charging station 405 and the second charging station 405, a score for the first charging station 405 and a score for the second charging station 405. DPS 485 can provide a score to a charging station 405 based on the power provided to or drawn from EVs 105, power provided to or drawn from EVs 105 over a period of time, maximum level of power provided to or drawn from the EVs 105, or the number of EVs 105 serviced by the charging station 405.

Data processing system 485 can provide, based on a comparison of the score for the first charging station 405 and the score for the second charging station 405, an indication 480 corresponding to one of the first charging station 405 and the second charging station 405. DPS 485 can compare the scores using the scoring function 465. DPS 485 can provide to an EV 105 seeking a charging station 405 to use, an indication 480 identifying or describing one of the first or the second charging station 405 that has the higher score. DPS 485 can provide to the EV 105 the indication 480 for the first or the second charging station 405 in response to determining that the first or the second charging station 405 to be indicated is within a threshold distance of the EV 105.

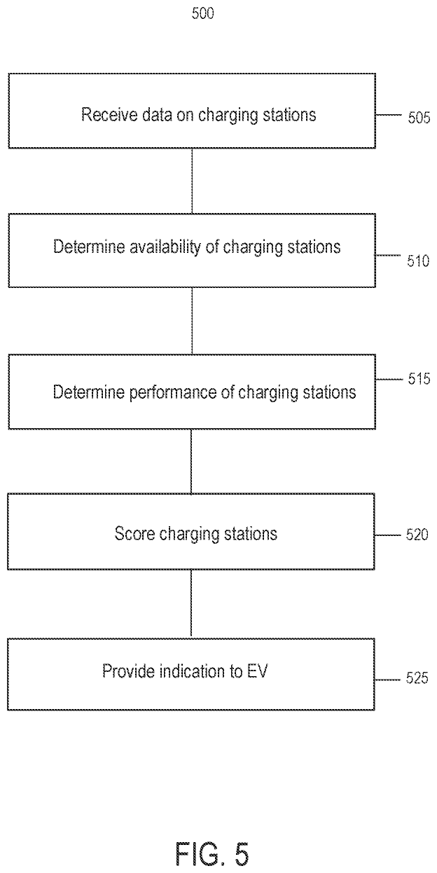

FIG. 5 illustrates a method 500 utilizing the system 400 from in FIG. 4 to provide an indication 480 to an EV 105 based on, or including, information on availability and performance of charging stations 405. Method 500 can provide information on availability and performance of charging stations 405 to EVs 105. The method can include ACTS 505-525. At ACT 505, the method receives data on charging stations. At ACT 510, the method determines availability of charging stations. At ACT 515, the method determines performance of charging stations. At ACT 520, the method scores charging stations. At ACT 525, the method provides indication to EV.

At ACT 505, the method receives data on charging stations. The one or more processors can receive, from a first electric vehicle, data regarding a first charging station. The data regarding the first charging station can including at least one of data corresponding to performance of the first charging station captured by the first electric vehicle via a power cable that couples the first electric vehicle with the first charging station and data corresponding to availability of the first charging station. The one or more processors can receive, from a second electric vehicle, data regarding a second charging station. The data regarding the second charging station can include at least one of data corresponding to performance of the second charging station captured by the second electric vehicle via a power cable that couples the second electric vehicle with the second charging station and data corresponding to availability of the second charging station.

The one or more processors can receive, from the first electric vehicle, the data regarding the first charging station comprising information that the first charging station provided service to the first electric vehicle. The one or more processors can receive, from one or more electric vehicles of a plurality of electric vehicles comprising the first electric vehicle and the second electric vehicle, the data regarding the second charging station comprising information corresponding to the one or more electric vehicles using one or more charging stations of a plurality of charging stations instead of the second charging station. The one or more processors can receive, from the first electric vehicle, the data regarding the first charging station comprising information corresponding to one or more charging events by the first electric vehicle with the first charging station. The one or more processors can receive, from the first electric vehicle, the data regarding the first charging station comprising information on a measured amount of power throughput between the first charging station and the first electric vehicle and a rated amount of power throughput between the first charging station and the first electric vehicle.

The one or more processors of a data processing system can receive from a plurality of electric vehicles, data corresponding to a plurality of charging stations. The data can include first data that can correspond to availability of the plurality of charging stations. The data can include second data that can correspond to performance of the plurality of charging stations. The second data can be captured by the plurality of electric vehicles via a plurality of power cables that couple the plurality of electric vehicles with the plurality of charging stations. The one or more processors can receive, from one or more electric vehicles of the plurality of electric vehicles, the data comprising information on whether the charging station provided service to the one or more electric vehicles. The one or more processors can receive, from one or more electric vehicles of the plurality of electric vehicles, the data comprising information corresponding to the one or more electric vehicles using one or more charging stations of the plurality of charging stations instead of the second charging station.

The one or more processors can receive, from one or more electric vehicles of the plurality of electric vehicles, the data comprising information corresponding to one or more charging events by the one or more electric vehicles with the charging station. The one or more processors can receive, from one or more electric vehicles of the plurality of electric vehicles, the data comprising information on an amount of power throughput between the charging station and the one or more electric vehicles. The one or more processors can receive, from one or more electric vehicles of the plurality of electric vehicles, the data comprising information on a measured amount of power throughput between the charging station and the one or more electric vehicles and a rated amount of power throughput between the charging station and the one or more electric vehicles. The one or more processors can identify that the charging station and the second charging station are within a threshold distance from the electric vehicle and receive, by the one or more processors from an electric vehicle, a notification that a charge level of the electric vehicle is below a threshold. The one or more processors can receive, from one or more electric vehicles of the plurality of electric vehicles, updated data corresponding to the first charging station and the second charging station.

At ACT 510, the method determines availability of charging stations. The one or more processors of a data processing system can determine, based on the data, availability of a charging station of the plurality of charging stations. The determination can be made based on the data received from the plurality of electric vehicles. The one or more processors can determine, based on the information on whether the charging station provided service to the one or more electric vehicles, the availability for the charging station. The one or more processors can determine, based on the information corresponding to the one or more electric vehicles using one or more charging stations of the plurality of charging stations instead of the second charging station, the availability for the second charging station. The one or more processors can determine, based on the information corresponding to one or more charging events by the one or more electric vehicles with the charging station, one of the availability or the performance of the charging station. For example, a data processing system can determine that a charging station is not available in response to data of charging station includes no electric vehicles using the charging station for a period of time, such as a two days, a week, two weeks or more. For example, a data processing system can determine that a charging station is not available based on electric vehicle data indicating that electric vehicles in the area do not stop to use that charging station, but instead use other charging stations in the area in which the charging station is located. For example, a data processing system can determine that a charging station is not available based on electric vehicle data indicating that one or more electric vehicles attempted to connect to the charging station, but failed to establish a connection.

At ACT 515, the method determines performance of charging stations. The one or more processors can determine, based on the data captured via a power cable of the plurality of power cables, performance of the charging station. The one or more processors can determine one of availability or performance of the charging station based on the information corresponding to one or more charging events by the one or more electric vehicles with the charging station. The information can include data on session attempts that are successful or not successful by one or more electric vehicles or an indication from an electric vehicle or its driver that the electric vehicle is not operational or available. The one or more processors can determine the performance of the charging station based on the information on a measured amount of power throughput between the charging station and the one or more electric vehicles and a rated amount of power throughput between the charging station and the one or more electric vehicles. The one or more processors can determine performance of the charging station based on a ratio of the measured amount of power throughput and the rated amount of power throughput. The one or more processors can determine updated availability and updated performance of each of the first charging station and the second charging station based on updated data.

For example, the one or more processors can determine performance of the charging station based on a ratio between a power, current or voltage measured by an electric vehicle and the power, current or voltage rating of the charging station. For example, if the power measured by the electric vehicle coupled to the charging station via a power cable, is as high or higher than the rated power of the charging station, data processing system can determine that the charging station has a high performance. If the power measured by the electric vehicle coupled to the charging station via a power cable, is as a fraction of the rated power of the charging station, data processing system can determine that the charging station has a low performance. For example, if a power level provided by the charging station to a charging electric vehicle is about 90% of the rated power level, the performance of that charging station can be determined to be greater than the performance of a charging station whose power level provided is about 60% of the rated power level. Data processing system can determine that one charging station has a higher performance than another charging station based on a total power output. For example, if a first charging station has a power output of 250 kW out of the rated 350 kW (e.g., about 70%), while a second charging station provides 150 kW out of the rated 150 kW (e.g., about 100%), data processing system can determine that the first charging station has a higher performance.

At ACT 520, the method scores charging stations. The one or more processors can generate a score for the charging station based on the availability and the performance. For example, data processing system can utilize a model to generate a score based on the availability determined at ACT 510 and performance determined at ACT 515. The model can be a rules-based model. The model can be a machine learning or an artificial intelligence model. The data processing system can determine the score for a charging station as an output of ML or Al model based on availability determined at ACT 510 and performance 515 determined at ACT 515 being input into the ML or Al model. The one or more processors can generate updated score for the charging station and the second updated score for the second charging station based on updated availability and updated performance determined at ACTS 510 and 515. For example, a data processing system can determine a score for a charging station and receive updated information on the charging station. The data processing system can determine an updated score for the charging station based on the updated information.

At ACT 525, the method provides indication to EV. The one or more processors can provide an indication corresponding to the charging station based on a comparison of the score for the charging station with a second score for a second charging station of the plurality of charging stations. For example, a data processing system can compare the first score of a first charging station and a second score of a second charging station, where both the first and the second charging stations are within the threshold distance from the electric vehicle. The data processing system can, via comparison, determine that the first charging station has a higher score than the second charging station. The data processing system can provide both the first and the second scores, via the indication, to the electric vehicle. The indication can include the first score and its availability as determined at ACT 510, as well as the performance as determined at ACT 515. The one or more processors can provide to the electric vehicle the indication corresponding to the availability and performance of the charging station and the second charging station, responsive to, or based on, the identification that the charging station and the second charging station are within a threshold distance from the electric vehicle and the notification that a charge level of the electric vehicle is below a threshold. The one or more processors can provide, in response to the updated score exceeding the second updated score, an updated indication corresponding to one of the charging station or the second charging station.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, a positive or a negative terminal of a battery, or power direction when an electric vehicle is charged or discharged. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a data processing system having one or more processors coupled with memory, to:
receive, from a first electric vehicle, data regarding a first charging station, the data regarding the first charging station including at least one of data corresponding to performance of the first charging station captured by the first electric vehicle via a power cable that couples the first electric vehicle with the first charging station and data corresponding to availability of the first charging station;
receive, from a second electric vehicle, data regarding a second charging station, the data regarding the second charging station including at least one of data corresponding to performance of the second charging station captured by the second electric vehicle via a power cable that couples the second electric vehicle with the second charging station and data corresponding to availability of the second charging station;
determine, based on the data regarding the first charging station and the data regarding the second charging station, availability of at least one of the first charging station and the second charging station;
determine, based on at least one of the data corresponding to performance of the first charging station and the data corresponding to performance of the second charging station, performance of at least one of the first charging station and the second charging station;
generate, based on the availability of at least one of the first charging station and the second charging station and the performance of at least one of the first charging station and the second charging station, a score for the first charging station and a score for the second charging station; and
provide, based on a comparison of the score for the first charging station and the score for the second charging station, an indication corresponding to one of the first charging station and the second charging station.

2. The system of claim 1, comprising the data processing system to:
receive, from the first electric vehicle, the data regarding the first charging station comprising information that the first charging station provided service to the first electric vehicle; and
determine, based on the information, the availability of the first charging station.

3. The system of claim 1, comprising the data processing system to:
receive, from one or more electric vehicles of a plurality of electric vehicles comprising the first electric vehicle and the second electric vehicle, the data regarding the second charging station comprising information corresponding to the one or more electric vehicles using one or more charging stations of a plurality of charging stations instead of the second charging station; and
determine, based on the information, that the second charging station is not available.

4. The system of claim 1, comprising the data processing system to:
receive, from the first electric vehicle, the data regarding the first charging station comprising information corresponding to one or more charging events by the first electric vehicle with the first charging station; and
determine, based on the information, at least one of the availability or the performance of the first charging station.

5. The system of claim 1, comprising the data processing system to:
receive, from the first electric vehicle, the data regarding the first charging station comprising information on an amount of power throughput between the first charging station and the first electric vehicle; and
determine, based on the information, the performance of the first charging station.

6. The system of claim 1, comprising the data processing system to:
receive, from the first electric vehicle, the data regarding the first charging station comprising information on a measured amount of power throughput between the first charging station and the first electric vehicle and a rated amount of power throughput between the first charging station and the first electric vehicle; and
determine, based on a ratio of the measured amount of power throughput and the rated amount of power throughput, performance of the first charging station.

7. The system of claim 1, comprising the data processing system to:
identify that the first charging station is within a threshold distance from an electric vehicle of a plurality of electric vehicles comprising the first electric vehicle and the second electric vehicle;
identify that the second charging station is within the threshold distance; and
provide, to the electric vehicle responsive to the identification, the indication.

8. The system of claim 1, comprising the data processing system to:
receive, from an electric vehicle of a plurality of electric vehicles comprising the first electric vehicle and the second electric vehicle, a notification that a charge level of the electric vehicle is below a threshold;
identify that the first charging station is within a threshold distance from the electric vehicle; and
provide, to the electric vehicle, responsive to the identification and the notification, the indication corresponding to the first charging station.

9. The system of claim 1, comprising the data processing system to:
receive, from an electric vehicle of a plurality of electric vehicles comprising the first electric vehicle and the second electric vehicle, a notification that the electric vehicle is to be charged;
identify that the first charging station and the second charging station are within a threshold distance from a path that the electric vehicle is expected to travel; and
provide, responsive to the identification, the indication.

10. The system of claim 1, comprising the data processing system to:
identify that the first charging station and the second charging station are within a threshold distance of the electric vehicle; and
provide, to a mobile application, the indication.

11. The system of claim 1, comprising the data processing system to:
receive, from one or more electric vehicles of a plurality of electric vehicles comprising the first electric vehicle and the second electric vehicle, updated data regarding the first charging station and updated regarding the second charging station;
determine, based on the updated data regarding the first charging station and the updated data regarding the second charging station, updated availability and updated performance of the first charging station and the second charging station;
generate, based on the updated availability and updated performance, an updated score for the first charging station and an updated score for the second charging station; and
provide, in response to the updated score for the first charging station and the updated score for the second charging station, an updated indication corresponding to at least one of the first charging station and the second charging station.

12. A method, comprising:
receiving, by one or more processors from a first electric vehicle, data regarding a first charging station, the data regarding the first charging station including at least one of data corresponding to performance of the first charging station captured by the first electric vehicle via a power cable that couples the first electric vehicle with the first charging station and data corresponding to availability of the first charging station;
receiving, by the one or more processors from a second electric vehicle, data regarding a second charging station, the data regarding the second charging station including at least one of data corresponding to performance of the second charging station captured by the second electric vehicle via a power cable that couples the second electric vehicle with the second charging station and data corresponding to availability of the second charging station;
determining, by the one or more processors, based on the data regarding the first charging station and the data regarding the second charging station, availability of at least one of the first charging station and the second charging station;
determining, by the one or more processors, based on at least one of the data corresponding to performance of the first charging station and the data corresponding to performance of the second charging station, performance of at least one of the first charging station and the second charging station;
generating, by the one or more processors, based on the availability of at least one of the first charging station and the second charging station and the performance of at least one of the first charging station and the second charging station, a score for the first charging station and a score for the second charging station; and
providing, by the one or more processors, based on a comparison of the score for the first charging station and the score for the second charging station, an indication corresponding to at least one of the first charging station and the second charging station.

13. The method of claim 12, comprising:
receiving, by the one or more processors from the first electric vehicle, the data regarding the first charging station comprising information that the first charging station provided service to the first electric vehicle; and
determining, by the one or more processors, based on the information, the availability of the first charging station.

14. The method of claim 12, comprising:
receiving, by the one or more processors from one or more electric vehicles of a plurality of electric vehicles comprising the first electric vehicle and the second electric vehicle, the data regarding the second charging station comprising information corresponding to the one or more electric vehicles using one or more charging stations of a plurality of charging stations instead of the second charging station; and
determining, by the one or more processors based on the information, the availability for the second charging station.

15. The method of claim 12, comprising:
receiving, by the one or more processors from the first electric vehicle, the data regarding the first charging station comprising information corresponding to one or more charging events by the first electric vehicle with the first charging station; and
determining, by the one or more processors based on the information, one of the availability or the performance of the first charging station.

16. The method of claim 12, comprising:
receiving, by the one or more processors from the first electric vehicle, the data regarding the first charging station comprising information on an amount of power throughput between the first charging station and the first electric vehicle; and
determining, by the one or more processors based on the information, the performance of the first charging station.

17. The method of claim 12, comprising:
receiving, by the one or more processors from the first electric vehicle, the data regarding the first charging station comprising information on a measured amount of power throughput between the first charging station and the first electric vehicle and a rated amount of power throughput between the first charging station and the first electric vehicle; and
determining, by the one or more processors based on a ratio of the measured amount of power throughput and the rated amount of power throughput, performance of the first charging station.

18. The method of claim 12, comprising:
identifying, by the one or more processors that the first charging station and the second charging station are within a threshold distance from an electric vehicle of a plurality of electric vehicles comprising the first electric vehicle and the second electric vehicle;
receiving, by the one or more processors from the electric vehicle, a notification that a charge level of the electric vehicle is below a threshold; and
providing, by the one or more processors to the electric vehicle responsive to the identification and the notification, the indication.

19. The method of claim 12, comprising:
receiving, by the one or more processors from one or more electric vehicles of a plurality of electric vehicles comprising the first electric vehicle and the second electric vehicle, updated data regarding the first charging station and updated regarding the second charging station;
determining, by the one or more processors based on the updated data regarding the first charging station and the updated data regarding the second charging station, updated availability and updated performance of the first charging station and the second charging station;
generating, by the one or more processors based on the updated availability and updated performance, an updated score for the first charging station and an updated score for the second charging station; and
providing, by the one or more processors, in response to the updated score for the first charging station and the updated score for the second charging station, an updated indication corresponding to at least one of the first charging station and the second charging station.

20. A non-transitory computer-readable medium storing instructions that, when executed by at least one processor, cause the at least one processor to:
receive, from a first electric vehicle, data regarding a first charging station, the data regarding the first charging station including at least one of data corresponding to performance of the first charging station captured by the first electric vehicle via a power cable that couples the first electric vehicle with the first charging station and data corresponding to availability of the first charging station;
receive, from a second electric vehicle, data regarding a second charging station, the data regarding the second charging station including at least one of data corresponding to performance of the second charging station captured by the second electric vehicle via a power cable that couples the second electric vehicle with the second charging station and data corresponding to availability of the second charging station;
determine, based on the data regarding the first charging station and the data regarding the second charging station, availability of at least one of the first charging station and the second charging station;
determine, based on at least one of the data corresponding to performance of the first charging station and the data corresponding to performance of the second charging station, performance of at least one of the first charging station and the second charging station;
generate, based on the availability of at least one of the first charging station and the second charging station and the performance of at least one of the first charging station and the second charging station, a score for the first charging station and a score for the second charging station; and
provide, based on a comparison of the score for the first charging station and the score for the second charging station, an indication corresponding to at least one of the first charging station and the second charging station.
